(19) United States
(12) Patent Application Publication
(10) Pub. No.: US 2020/0184564 A1
(43) Pub. Date: Jun. 11, 2020

(54) Dynamically-Generated Electronic Database for Portfolio Selection

(71) Applicant: Kim Hwa LIM, Penang (MY)

(72) Inventor: Kim Hwa LIM, Penang (MY)

(21) Appl. No.: 16/611,860

(22) PCT Filed: Jul. 13, 2017
(86) PCT No.: PCT/SG2017/050352

§ 371 Date: Nov. 8, 2019

(30) Foreign Application Priority Data
May 8, 2017 (MY) 2017701611

(51) Int. Cl. G06Q 40/06; G06Q 10/06

(52) U.S. Cl. CPC G06Q 40/06; G06Q 10/067

(57) ABSTRACT

The present invention relates to a system and method for executing a selection from a dynamically-generated electronic database. The database includes a selection parameter determination engine creating selection parameters according to statistical models for weighting desirability of financial instruments combined with entered user selection preferences. Each financial instrument is electronically associated with a dynamic electronic label indicating whether the financial instrument is restricted for selection. The selection parameters are electronically converted by a selector engine to electronic output; the selector engine electronic output can be validated based on previously determined outcome parameters associated with past outcomes for the financial instruments. A computer processor executes external selections from a real-time updating external electronic exchange database based on the electronic output of the selector engine. Selection limiters prevent execution of external selections based on electronic flags.

### FIELD OF THE INVENTION

The present invention relates generally to improvements in electronic processing systems, particularly, electronic databases used for determining selections from real-time-updated electronic exchanges. The novel electronic database structure is dynamically generated for selection of financial instruments with user specified inputs.

### BACKGROUND

Current techniques for achieving financial goals by automatically creating an optimal financial instruments portfolio are limited. Databases may be based solely on various market factors with no mechanism for customization based on various user selection preferences or user needs. Automatic portfolio selection is typically limited to exchange-traded funds (ETFs) in which the financial instruments selected match those of a particular exchange, linking the portfolio performance solely to the performance of that index without a clear link to how to achieve the financial goals.

Alternatively, investors may purchase mutual funds in which a large portfolio management entity selects financial instruments for inclusion based on the portfolio management entity's knowledge and research. These funds do not allow customization of the underlying securities based on individual investor preference such as a desire to support green technology or avoiding financial instruments originating in certain countries. Users are also not able to combine investment funds in a way that directly enables them to achieve their goals optimally.

Individual investors typically do not possess all the information to create an optimal portfolio and to rebalance it consistently in the future. Due to the fact that financial instruments are purchased on a real-time-updated exchange, it is technically impossible for human being to evaluate all of the factors needed to optimize and manage a financial instrument portfolio in real time. As used herein, the term “financial instrument” includes stocks, bonds, contracts related to the purchase of stocks or bonds, packages of capital, currency, funds, or any assets that can be traded by means of a representation on an electronic exchange.

Due to the ever changing user's financial requirements and the technical problem of being unable to process all the information needed to create and maintain a customized portfolio in real time, there is a need in the art to dynamically create an electronic database that evaluates various variables in real time to enable selection from a real-time electronic exchange based on attributes identified by the dynamically-created electronic database.

### SUMMARY OF THE INVENTION

The present invention relates to a system, including an electronic database, and a method for executing a selection from a dynamically-generated electronic database. The database includes a selection parameter determination engine creating selection parameters according to statistical models for weighting desirability of financial instruments combined with user entered selection preferences for financial instruments. Each financial instrument is electronically associated with a dynamic electronic label indicating whether the financial instrument is restricted for selection at least in part based upon user entered selection preferences. The selection parameters are electronically converted by a selector engine to electronic output; the selector engine electronic output can be validated based on previously determined outcome parameters associated with past outcomes for the financial instruments in the electronic output of the selector engine.

A computer processor is configured for executing external selections from a real-time updating external electronic exchange database based on the electronic output of the selector engine, the computer processor including electronic selection limiters to prevent execution of external selections based on electronic flags computed from electronic checks relating to the amount and type of external selections.

### BRIEF DESCRIPTION OF THE DRAWINGS

Embodiments of the invention are described in more details hereinafter with reference to the drawings, in which:

FIG. 1 schematically depicts an electronic processing system including dynamically-created electronic data storage;

FIG. 2 schematically depicts various details of the electronic processing system of FIG. 1;

FIG. 3 schematically depicts an external data filter in the electronic processing system of claim 1;

FIG. 4 schematically depicts a portfolio construction engine in the electronic processing system of claim 1;

FIG. 5 schematically depicts a flow chart of the process in the execution platform in the electronic processing system of claim 1; and

FIG. 6 schematically depicts a flow chart of the ‘backtest’ operation process in the portfolio modeler in the electronic processing system of claim 1.

### DETAILED DESCRIPTION

In the following description, methods, apparatus, and systems for making financial instrument selection and creating a dynamic electronic database upon which to base financial instrument selection are set forth as preferred examples. It will be apparent to those skilled in the art that modifications, including additions and/or substitutions may be made without departing from the scope of the invention. Specific details may be omitted so as not to obscure the invention; however, the disclosure is written to enable one skilled in the art to practice the teachings herein without undue experimentation.

The electronic embodiments disclosed herein may be implemented using general purpose or specialized computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

All or portions of the electronic embodiments may be executed in one or more general purpose or specialized computing devices including server computers, personal computers, laptop computers, mobile computing devices such as smartphones' and ‘tablet computer’, one or more general purpose or specialized processors and electronic circuitries.

The electronic embodiments include user interfaces and computer storage media having computer instructions or software codes stored therein which can be used to program computers or microprocessors to perform any of the processes of the present invention. The user interfaces may be using webpages, apps, chatbots, and/or other means of communication and interaction with the user. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

As used herein, the expression “dynamically-created database” relates to a collection of information that is organized so that it can be easily accessed and managed and is updated by various calculated results of various computer programs and while factoring in customizable preference data. The term “database” is used broadly and may include computer program storage regions for storing executing computer programs that act upon the database to dynamically create and store data therein. Thus the database may reside in various regions of memory that include both information and computer instructions for acting upon information.

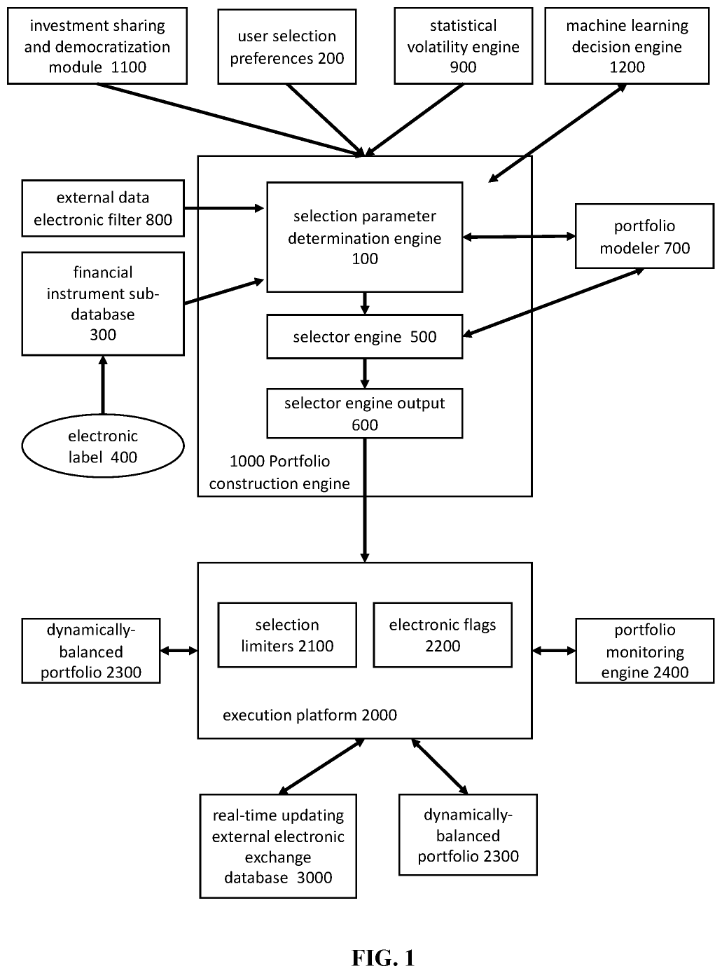

Turning to the drawings in detail, FIG. 1 schematically depicts an overview of a system for executing a selection from a dynamically-generated electronic database. In one aspect, the system includes a portfolio construction engine 1000. Portfolio construction engine 1000 includes a selection parameter determination engine 100 creating selection parameters according to statistical models for weighting desirability of financial instruments. User selection preferences are communicated to selection parameter determination engine 100 by user selection preference entry unit 200. A financial instrument sub-database 300 includes various financial instruments that may be operated upon by the selection parameter determination engine 100. The financial instrument sub-database is dynamically updated with information from an external exchange database. Each financial instrument is electronically associated with a dynamic electronic label 400 indicating whether the financial instrument is restricted for selection. The dynamic electronic label may include a setting that toggles between approved and restricted.

The selection parameters are electronically converted by a selector engine 500 to electronic output; the selector engine electronic output 600 may optionally be validated based on previously determined outcome parameters associated with past outcomes for the financial instruments as determined by portfolio modeler 700, described in further detail below. An execution platform 2000 executes external selections from a real-time updating external electronic exchange database 3000 based on the electronic output 600 of the selector engine. Selection limiters 2100 prevent execution of external selections based on electronic flags 2200 computed from electronic checks relating to the amount and type of external selections. Selected financial instruments are input to a dynamically-balanced portfolio 2300 which is updated according to user specifications at any given frequency.

An external data electronic filter 800 may provide input to the selection parameter determination engine 100. External data electronic filter 800, described in further detail below, eliminates noise from external data through electronic text processing, standardization and electronic pre-computation.

A statistical volatility engine 900 may further provide input to the selection parameter determination engine 100. By providing data regarding financial instrument volatility, the selection parameter determination engine 100 may limit selection of certain financial instruments with an undesirable level of volatility. Optionally, a machine learning decision engine 1200 adapts user-defined parameters to the external data to improve decision making allocation and prevent unnecessary churn in the results generated by the external data electronic filter 800 and the statistical volatility engine 900.

The system may optionally include an investment sharing and democratization module 1100 that provides another input to the selection parameter determination engine 100. The investment sharing and democratization module 1100 accesses the invention portfolio and strategy data of users/investors of the system, and provides a user interface that allows each user/investor to specify whether to share her investment strategy with others, and whether to follow one or more other users/investors' investment strategies as the target investment strategies. The user interface also allows each user/investor to specify a variable degree of imitation of own investment strategy to the specified target investment strategies. The variable degree of imitation can range from identical tracking of investment portfolio and strategy without the user/investor's intervention to, as example without limitation, tracking of selected financial instruments.

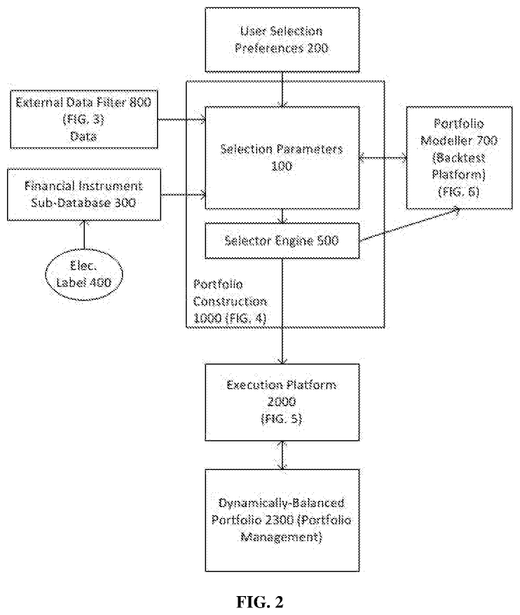

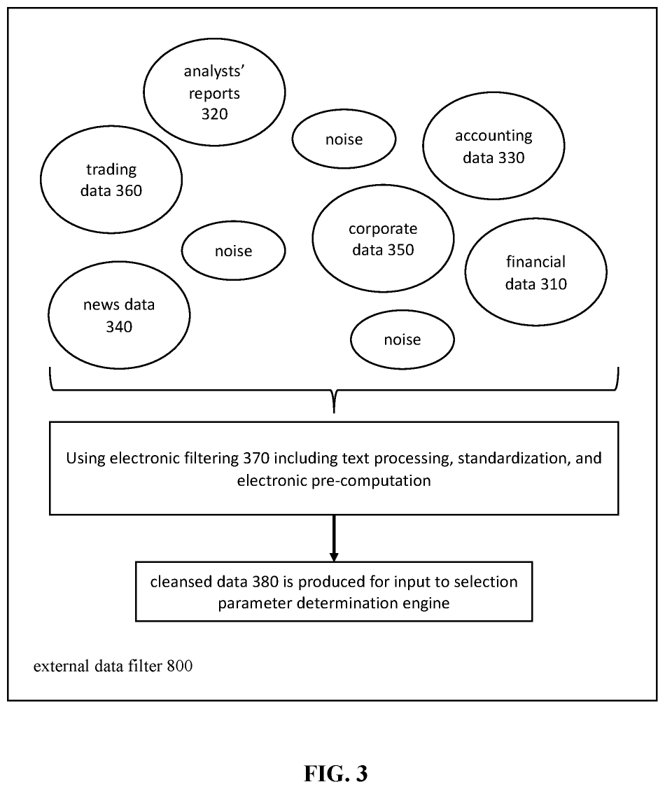

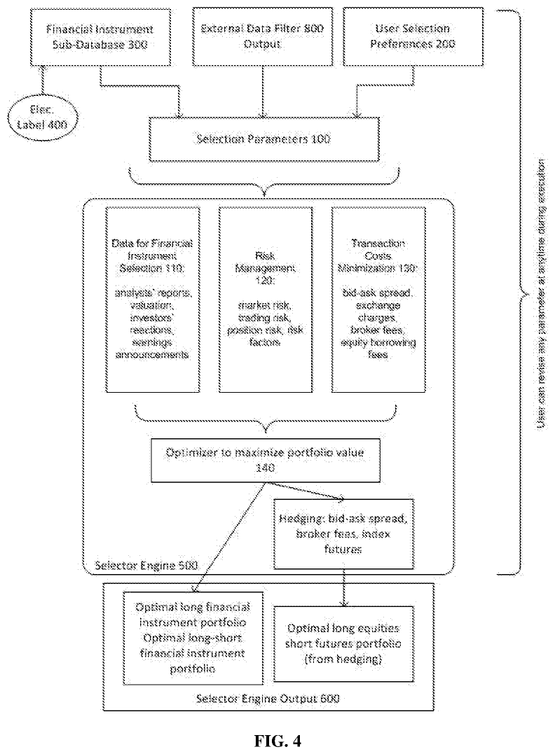

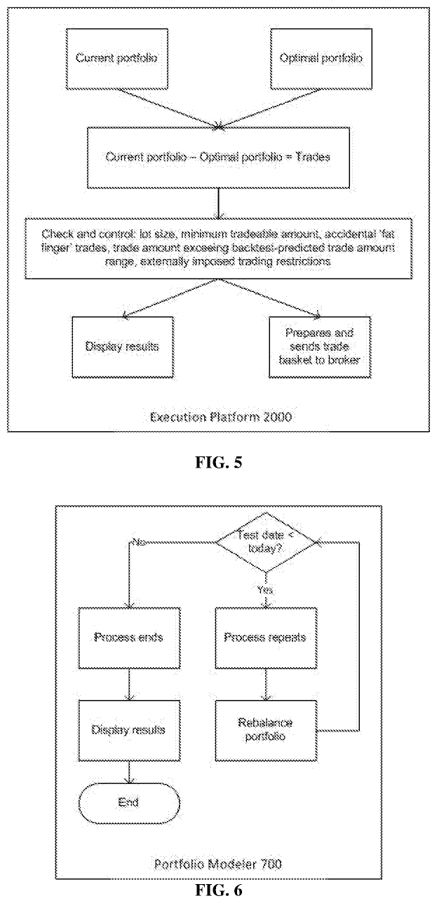

FIG. 2 focuses on the interaction of various aspects of FIG. 1 and indicates which subsequent FIGS. include further details concerning these aspects of the invention. As seen in FIG. 2, the external data filter 800 is presented in FIG. 3, the portfolio construction engine 1000 is presented in FIG. 4, the process flow of the execution platform 2000 is presented in FIG. 5, and the ‘backtest’ operation process flow of the portfolio modeler platform is presented in FIG. 6.

Concerning user selection preferences 200, the present invention can dynamically accept and update user preferences regarding acquisition or divestment of financial instruments, capturing an individual investor's needs, preferences, and investment principles such that an individually bespoke and dynamically balanced portfolio is developed. Examples of user/investor preferences include individual principles (e.g. invest in only clean technology), objectives (e.g. for retirement, property purchase, etc.), risk-reward tolerance (e.g. aggressive growth vs. preservation of capital), capital vs. income needs (e.g. does the investor rely on dividends for income?), savings and spending pattern (e.g. how much to save and spending which can be varied in the future as the user's life progresses). As the user preferences may be dynamically changed, the resulting database, investment plan and portfolio are also dynamically changed.

Turning to FIG. 3, external data electronic filter 800 is presented. Various sources of external data are optionally sent to the selection parameter determination engine 100. As seen in FIG. 3, the various sources of external data such as financial data 310, analysts' reports 320, accounting data 330, news data 340, corporate data 350, and trading data 360 are interspersed with “noise” such as advertisements or false news reports. Using electronic filtering 370 including text processing, standardization, and electronic pre-computation, cleansed data 380 is produced for input to selection parameter determination engine 100 (FIG. 1). The electronic filtering 370 also cleans the external data in regards to certain extraordinary corporate events such as dividend payouts and stock splits.

FIG. 4 presents features of the portfolio construction engine 1000. As seen in FIG. 4, selection parameters engine 100 receives input from the financial instrument sub-database 300, external data filter 800, and user selection preferences 200. Operating in connection with this input are data section 110, risk management unit 120, and transactions cost minimization unit 130 in the selector engine 500. Data section 110 may include analysts' reports; behavioural finance may also be considered such as investors' reaction (overreaction, overconfidence) to earnings announcements as measured in market movement; momentum and reversion may also be tracked. Other valuation measures are determined in the data section such as price to earnings ratio, dividend yield, market to book, and price/cash. Various computer programs may be run in the data section 110 to do preliminary calculations regarding terminal/present value, annuity value, discount rate and financial instrument selection, including standardization of various financial measurements into a common currency such as US dollars or Euros.

In an alternative embodiment, the portfolio construction engine 1000 may optionally utilize the optional machine learning decision engine 1200 that utilizes an artificial neural network, such as a nonlinear autoregressive network with exogenous inputs, to optimize decision allocation within strategy and across strategies.

Risk management unit 120 takes input from user preferences regarding risk (e.g., aggressive growth vs. risk-averse preservation of capital) and combines it with an analysis of market risk, trading risk, position risk, and other risk factors. Risk management unit also may include information generated from statistical volatility engine 900 including CAPM beta, betas with respect to other factors (oil, USD etc.), industry-adjusted betas. Risk management unit 120 may optionally compute minimum and maximum size positions for contemplated financial instruments or the asset classes.

Cost minimization unit 130 factors in costs associated with acquiring financial instruments in determining whether various financial instruments should be selected. Unit 130 may communicate with external real-time updating electronic exchange database 3000 in obtaining or calculating fees. Such fees may include the bid-ask spread, exchange charges, broker fees, fund management fees and stock borrow fees, among others.

The above three sections, data section 110, risk management unit 120, and transaction cost minimization unit 130 are factored in to the optimizer 140 to maximize portfolio value. Section 140 optimizes a financial instrument distribution in order to maximize the value to the portfolio. Suppose that there are n different financial instruments. Regardless of the underlying distribution of financial instruments returns, a collection of n financial instruments returns y₁, . . . yₙ has a mean of financial instruments returns:

$$m = \frac{1}{n} {\sum }_{n = 1}^{n} {y}_{n}$$

And (sample) covariance of financial instruments returns:

$$C = \frac{1}{n - 1} {\sum }_{n = 1}^{n} ( {y}_{n} - m ) {( {y}_{n} - m )}^{T}$$

where C denotes the covariance matrix of rates of financial instruments return. The risk of each financial instrument i has the expected value of uᵢ. The optimizer will find out what fraction xᵢ to invest in each financial instrument i in order to maximize value, subject to various risk requirements.

The classical mean-variance model consists of maximizing portfolio value, as measured by

½x^{T}Cx

subject to a set of constraints. The expected risk should be no more than the maximum risk r that an investor desires,

$${\sum }_{i = 1}^{n} {u}_{i} {x}_{i} \leq {r}_{i}$$

The sum of the investments in financial instruments fractions xᵢ should sum to one,

$${\sum }_{i = 1}^{n} {x}_{i} = 1$$

And, being fractions, xᵢ should be between zero and one.

0≤xᵢ≤1,i==1 . . . n.

After the optimizer section 140, the selection preferences section determines whether there should be hedged positions in section 150. As used herein, the term “hedge” relates to investment in a second financial instrument to reduce the risk of adverse price movements in a first financial instrument. Typically these are related financial instruments such as a futures contract in an underlying security in a portfolio or a short-sale of the security. In determining the effect of a hedged position, section 150 evaluates the bid-ask spread, broker fees for contracts, index futures, and/or the costs of equity borrowing.

Selection parameters engine 100 also acts on financial instrument sub-database 300 as constrained by electronic labels 400. The financial instruments sub-database may be organized by geography, industry, themes, and/or financial instrument characteristics. The electronic labels indicate whether a stock is available for portfolio construction in the optimizer according to user preferences and other factors determined from selection parameters 100. The labels are dynamically updated as new information becomes available. Selector engine 500 further receives all of the selection parameters determined in selection parameters engine 100 in order to compute a trade basket of financial instruments that can be executed by the execution platform 2000 to generate a dynamically-balanced portfolio 2300.

The selector engine may run various computer programs in order to determine the final trade basket. These programs may load a pre-execution portfolio and then control for trading restrictions such as stocks not to be bought/sold/traded/shorted/stocks to be liquidated. Additional risks checks for compliance, sanity, and ‘fat finger’ trades may be performed by selector engine 500. The selector engine 500 may also optionally standardize various financial measurements into a common currency such as US dollars or Euros. The selector engine 500 may also utilize a standardized value of data 110 as set forth below:

$$Standardized Value = Confidence Weight ( \% ) * \frac{\begin{matrix}[ Ranking of value - \\ ( Sum of number of stocks with value ) * 0.5 ]\end{matrix}}{Sum of number of stocks with value}$$

After all of the various computations are made in the selector engine 500, a final trade basket is sent to selector engine output 600. The output may be sorted by regular trades and those trades for which hedging will be performed. The regular trades include financial instruments for an optimal “long” portfolio (that is, financial instruments intended to be owned), an optimal long equities/short equities portfolio. For hedged instruments there is an optimal long equities/short futures portfolio. The selector engine output 600 may be sent to the execution platform 2000, which will communicate with exchange 3000 for execution of trades.

FIG. 5 depicts details of the operation of the execution platform 2000. The optimal funds portfolio, optimal long equities portfolio, optimal long equities/short equities portfolio, or hedged optimal long equities/short equities portfolio received from the selector engine output 600 is first compared with the current portfolio executed. The differences are extracted and form the new trades to be executed. The new trades are finally checked against a group of parameters including lot size, minimum tradeable amount, accidental ‘fat finger’ trades, trade amount exceeding ‘backtest’-predicted trade amount range, and externally imposed trading restrictions. The checked trades are properly data-formatted and packaged into trade orders to be sent to the broker via an optional automated orders routing and placing sub-system 2300 (as shown in FIG. 1), which automatically routes and places the trade orders to brokers of a stock exchange and captures the trade order status. A trade order in non-base currency can be optionally paired with an equivalent foreign exchange order that is executed conditional upon the successful execution of the trade order. The automated orders routing and placing sub-system 2300 may be an external system. The checked trades and order status are also displayed to the user.

Turning to FIG. 1 again. In one embodiment, the system includes a portfolio monitoring engine 2400. The engine enables users to maximise payoff whilst limiting the downside. To achieve this, a user can pre-programme her desired stop losses and take profits levels. To maximise profits, the system hold on continuously to a long position of a specific financial instrument until its market price is above the user-defined take profits level price by which an order will automatically be placed so that the user can take advantage of sudden or unexpected changes in financial instrument prices. To limit the downside, the user specifies a limit on the maximum possible losses, without setting a limit on the maximum possible gain. The engine continuously recalculates the stop losses sell-trigger price and limit sell price at some points below the market price based on the user-defined amount of maximum possible losses. As the market price rises, both the stop losses sell-trigger price and the limit sell price rise proportionally, but if the stock price falls, the stop losses sell-trigger price remains unchanged, and when the stop losses sell-trigger price is hit, a limit order is submitted at the last calculated stop losses limit sell price.

FIG. 6 depicts details of the ‘backtest’ operation of the portfolio modeler 700. Portfolio modeler 700 permits users to electronically model a portfolio based on various user input preferences and to determine the value and performance of that model portfolio. Input from the portfolio modeler may be input to the selection parameters engine 100 for assistance in determining financial instrument selection. One of the features of portfolio modeler 700 is that it determines the past performance of any collection of financial instruments using the same set of parameters so that a user may determine if a particular investment strategy has yielded positive returns for any specified previous period of time. Using this information, a user can determine if a particular portfolio has “out-performed” the market in the past. The portfolio modeler may employ artificial intelligence to select and model a set of financial instruments based on various user input factors. Such factors include age, initial capital to be invested, long-term and short-term investment goals, risk preferences, opinions on economic issues such as inflation, and personal principles regarding selection of particular financial instruments. The portfolio modeler may include a user interface that elicits the above information using interactive questions to which a user may input answers.

The input of user input preferences to the portfolio modeler 700 can be conducted by interactive user questioning. The user's answers to the questions. Based on the answers, the portfolio modeler 700 selects and tests the performance of a group of financial instruments, provides appropriate advice, taking his/her financial goals into account, on the allocation of the user's capital into the recommended amount per investment strategy and/or group of financial instruments. As seen in FIG. 6, an iterative process determines the portfolio value and rebalances the portfolio from a specified prior date until the present date, displaying the final performance results. The user can also iteratively enter different set of answers to the questions, thereby generating different test scenarios. In this manner, a user may iteratively test various inputs and investment preference strategies until a successful combination is determined. This information may be shared with the selection parameters engine 100; the user may also capture this information by updating the user preferences 200 to reflect the output of the portfolio modeler 700.

The ‘backtest’ operation of the portfolio modeler 700 is substantially similar to the trade execution performed by the execution platform 2000. In both, the information ‘universe’ is filtered with data cleansed and standardized, followed by the generation of the optimal portfolios. Instead of comparing the optimal portfolio with the currently executing portfolio and create a trade basket to be executed, the backtest operation goes into a loop. In the backtest operation, information as of that particular date is used whereas in trade execution performed by the execution platform 2000 the latest information is used. The set of parameters, equations, and optimizer are the same and kept constant in both. As such the backtest operation creates a realistic situation of what it would have been in the past.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for executing a selection from a dynamically-generated electronic database comprising:
a dynamically-generated electronic database including a selection parameter determination engine creating selection parameters according to statistical models for weighting desirability of financial instruments combined with entered user selection preferences/objectives for financial instruments, each financial instrument electronically associated with a dynamic electronic label indicating whether the financial instrument is restricted for selection at least in part based upon entered user selection preferences, the selection parameters being electronically converted by a selector engine to electronic output, wherein the selector engine electronic output can be validated based on previously determined outcome parameters associated with past outcomes for financial instruments in the electronic output of the selector engine;
an execution platform comprising at least one computer processor configured for executing external selections from a real-time updating external electronic exchange database based on the electronic output of the selector engine, the execution platform including electronic selection limiters to prevent execution of external selections based on electronic flags computed from electronic checks relating to the amount and type of external selections.

2. The system of claim 1 further comprising an external data electronic filter to provide input to the selection parameters.

3. The system of claim 2 wherein the external data electronic filter wherein the external data electronic filter eliminates noise from external data through electronic text processing, standardization and electronic pre-computation.

4. The system of claim 1 wherein a statistical volatility engine provides input to the selection parameters.

5. The system of claim 1 further comprising a portfolio modeler to determine value and performance of a model portfolio based on user input preferences.

6. The system of claim 1 wherein the portfolio modeler determines the past performance of a model portfolio.

7. The system of claim 1 wherein the real-time updating external electronic exchange database is a stock exchange.

8. The system of claim 1 wherein the selector engine uses financial valuation data, risk management analysis, and transaction cost minimization to determine the selection parameters to be applied to a financial instruments database.

9. The system of claim 1 wherein the selection parameters engine optimizes portfolio value according to the equation:
$$Standardized Value = Confidence Weight ( \% ) * \frac{\begin{matrix}[ Ranking of value - \\ ( Sum of number of stocks with value ) * 0.5 ]\end{matrix}}{Sum of number of stocks with value}$$

10. The system of claim 1 wherein the selector engine determines whether hedging is applied.
